(19) United States
(12) Patent Application Publication
(10) Pub. No.: US 2009/0140538 A1
(43) Pub. Date: Jun. 4, 2009

(54) TRUCK BED EXTENDER

(75) Inventor: Richard Lowell Larson, Bloomington, MN (US)

Correspondence Address: MERCHANT & GOULD PC, P.O. BOX 2903, MINNEAPOLIS, MN, 55402-0903, US

(73) Assignee: Richard Lowell Larson, Bloomington, MN (US)

(21) Appl. No.: 12/183,840

(22) Filed: Jul. 31, 2008

Related U.S. Application Data
(60) Provisional application No. 60/962,992, filed on Aug. 2, 2007.

(51) Int. Cl. B60P 1/00; B60P 3/40

(52) U.S. Cl. 296/26.08; 224/42.32; 224/519; 29/525.01

(57) ABSTRACT

The present disclosure provides a device configured to attach to the end of a truck bed. The device can be conveniently used to support and/or secure objects to the truck that are longer than the truck bed. In some embodiments the device enables transport of objects that are longer than a truck bed without interfering with trailers being towed by the truck. A method of securing a wheeled vehicle to a truck bed is also provided.

### CROSS REFERENCES TO RELATED APPLICATIONS

This application claims the benefit of U.S. Provisional Application No. 60/962,992, filed Aug. 2, 2007, the disclosure of which is hereby incorporated by reference in its entirety.

### TECHNICAL FIELD

The present disclosure relates to a truck bed extender and a method of using the same.

### BACKGROUND

Transporting objects in a pickup truck, which are longer than the bed of the truck, can be challenging. Typically, the tailgate of the truck is left in the open position to support the object and to enable the object to fit level into the bed.

Transporting objects with the tailgate in the open position can be problematic. Tailgates are not typically designed to support a large amount of weight, and they typically are not configured to lock securely in an open position. When the tailgate of a truck is in the open position, the end portions of the tailgate can, in some towing configurations, limit the effective turning radius of the vehicle and trailer combination. In other words, in some towing situations a tailgate in an open position and the trailer towed behind the truck can run into each other if the driver makes a sharp turn. The present disclosure provides a device and method that facilitates transporting objects in a truck where the objects are longer than a truck bed.

### SUMMARY OF THE INVENTION

The present disclosure provides a device configured to attach to the end of the truck bed. The device can be conveniently used to support and/or secure objects to the truck that are longer than the truck bed. In some embodiments the device enables transport of objects that are longer than a truck bed without interfering with trailers being towed by the truck. A method of securing a wheeled vehicle to a truck bed is also provided.

### BRIEF DESCRIPTION OF THE DRAWINGS

FIG. 1 is an upper right rear perspective view of an embodiment of the bed extender according to the present disclosure attached to a vehicle and a ramp;

FIG. 2 is depicts an enlarged portion of FIG. 1 with the ramp removed;

FIG. 3 is an upper left rear perspective view of the bed extender shown in FIG. 1 with the tie down straps removed;

FIG. 4 is a lower left rear perspective view of the bed extender shown in FIG. 1;

FIG. 5 is an upper left side perspective view of a second embodiment of the bed extender according to the present disclosure;

FIG. 6 is a top view of the bed extender of FIG. 5;

FIG. 7 is a side view of the bed extender of FIG. 5;

FIG. 8 is a rear view of the bed extender of FIG. 5;

FIG. 9 is a perspective view of a hitch bracket of the bed extender of FIG. 5;

FIG. 10 is perspective view of a bed support of the bed extender of FIG. 5; and

FIG. 11 is a perspective view of a bed plate of the bed extender of FIG. 5.

### DETAILED DESCRIPTION

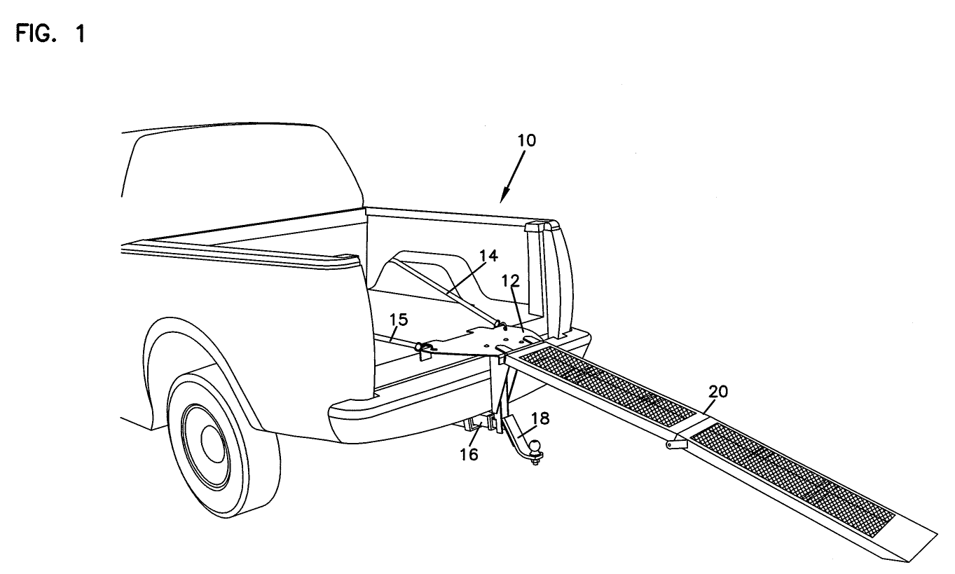

Referring to FIG. 1, a bed extender 12 according to an embodiment of the present disclosure is shown attached to a truck bed 10 and a ramp 20. In the depicted embodiment the truck bed 10 is of a pickup truck with the tailgate removed. The bed extender is posited adjacent the rear of the truck bed 10 and above the receiver 16. In the depicted embodiment, bed extender 12 rests on the hitch 18 and is held laterally against the truck bed 10 via straps 14, 15. The ramp 20 is shown connected to the bed extender 12 such that objects can be conveniently loaded and unloaded into the truck bed 10. For example, in the depicted configuration a motorcycle can be rolled into and out of the tuck bed 10.

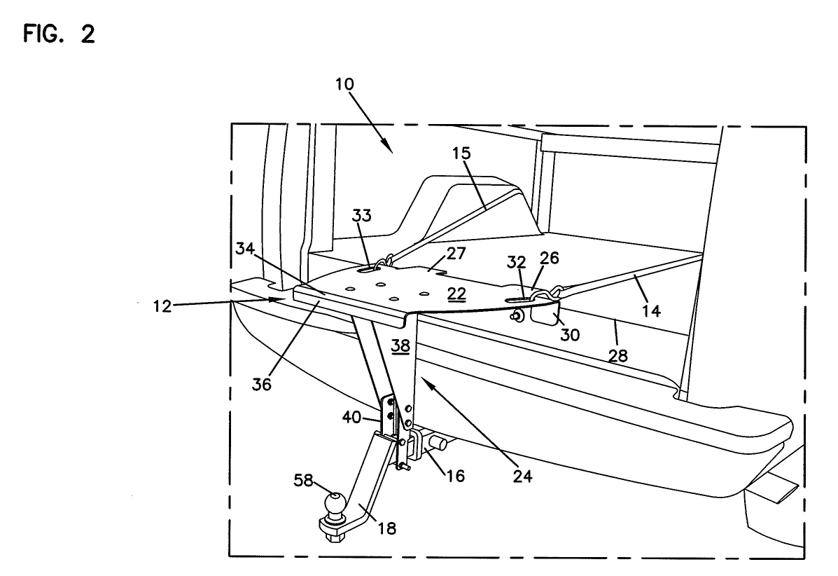

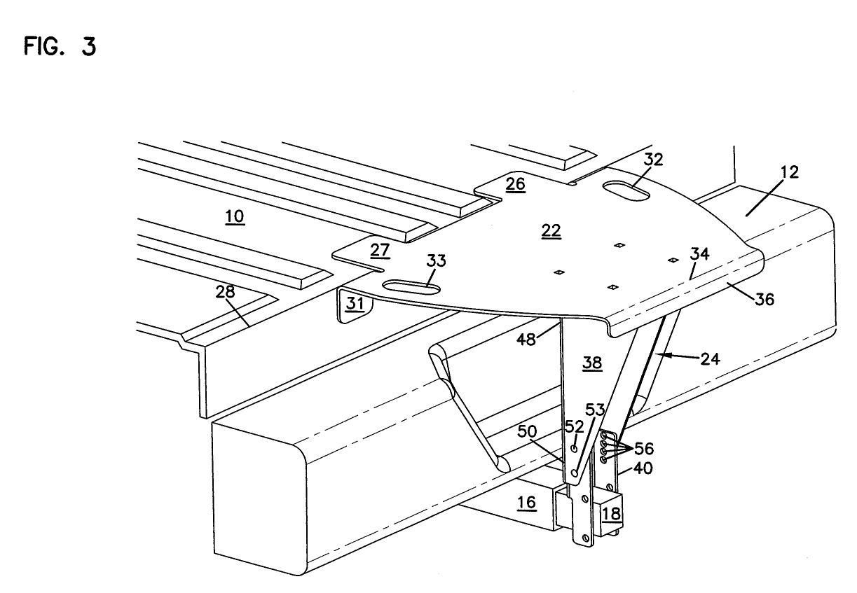

Referring to FIGS. 2 and 3, the bed extender 12 includes a table portion 22 (also referred to herein as a bed plate) connected to a hitch mounting assembly 24. In the depicted embodiment, the table portion 22 includes a pair of arms 26, 27 configured to rest over the back edge 28 of the truck bed 10 and a pair of bumpers 30, 31 configured to abut against the back edge 28 of the truck bed 10. In the depicted embodiment the arms 26, 27 are generally horizontal, and the bumpers 30, 31 are generally vertical. The table 22 includes a pair of attachment holes 32, 33 that can be used to engage straps 14, 15 that pull the bed extender 12 laterally against the truck bed 10. In the depicted embodiment the loading edge 34 includes a curved over lip portion 36. Though in the depicted embodiment the table portion 22 of the bed extender 12 is trapezoidal in shape with the longest edge adjacent the edge 28 of the truck bed 10, it should be appreciated that many other shapes and configurations are possible.

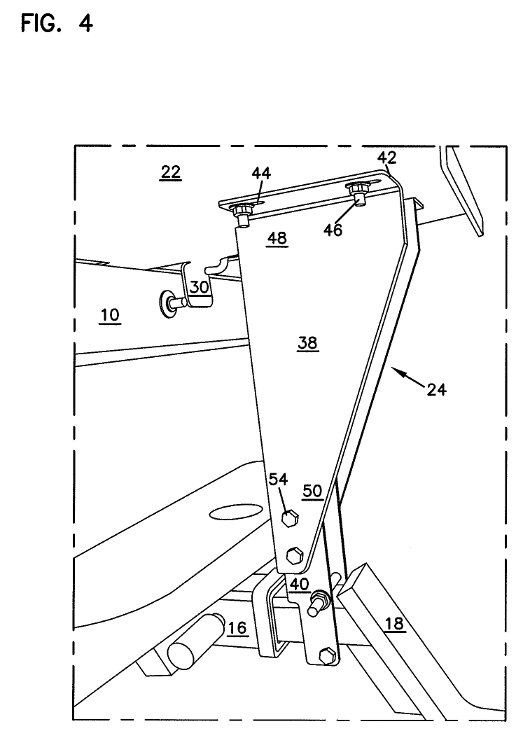

Referring to FIGS. 2-4, the hitch mounting assembly 24 of the bed extender 12 is described in greater detail. In the depicted embodiment, the hitch mounting assembly 24 includes a first vertical support member 38 (also referred to herein as a bed support) connected to the table 22 and a second vertical support member 40 configured to connect to a portion of the hitch 18. In the depicted embodiment, the first vertical support member 38 includes an upper end 48 with opposed flanges 42 that each have slots 44 configured to receive bolts 46 (FIG. 4). The slots 44 enable the lateral position of the hitch mounting assembly 24 and the table 22 to be adjusted. The lower end 50 of the first vertical support member 38 includes through holes 52, 53 that are configured to receive bolts 54 that attach the first vertical support member 38 to the second vertical support member 40.

In the depicted embodiment, the second vertical support member 40 (also referred to herein as a hitch bracket) is sized such that the table 22 can be supported in a generally horizontal position. The upper portion of the second vertical support member 40 can include a plurality of holes 56 to enable the level of the table 22 to be adjusted as desired. In other words, the plurality of holes 56 enables vertical adjustment and the slots 44 enable a lateral adjustment. In the depicted embodiment the second vertical support member 40 telescopes from the first vertical support member 38.

In the depicted embodiment the lower end of the second vertical support member 40 extends over a portion of the neck portion of the hitch 18 that is forward of the ball 58 (FIG. 2). The depicted configuration enables the bed extender 12 to be used even when the truck is used to tow a trailer (not shown). It should be appreciated that many other configurations for connecting the second vertical support member 40 to the vehicle are also possible. For example, the second vertical support member 40 could be configured to be received within the receiver 16 in place of the hitch 18. Such an embodiment could be used when the operator does not desire to use the vehicle for towing while using the bed extender 12.

The bed extender 12 can be used to transport a variety of different objects in a truck bed (e.g., motorcycles, snowmobiles, ATVs, couches, lumber, etc.). In the context of transporting a motorcycle, the device is used by securing it to the receiver of the truck, strapping it to the truck bed such that the table portion abuts the edge of the truck bed, connecting a ramp to the loading edge of the table, and rolling a motorcycle into the truck bed such that the front or the back wheel rests on the table portion of the bed extender.

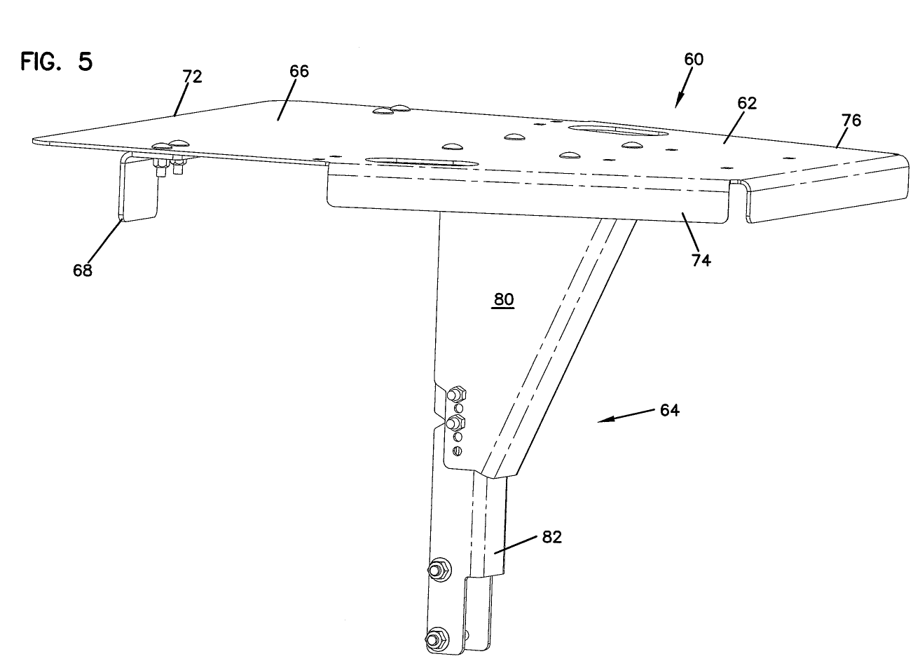

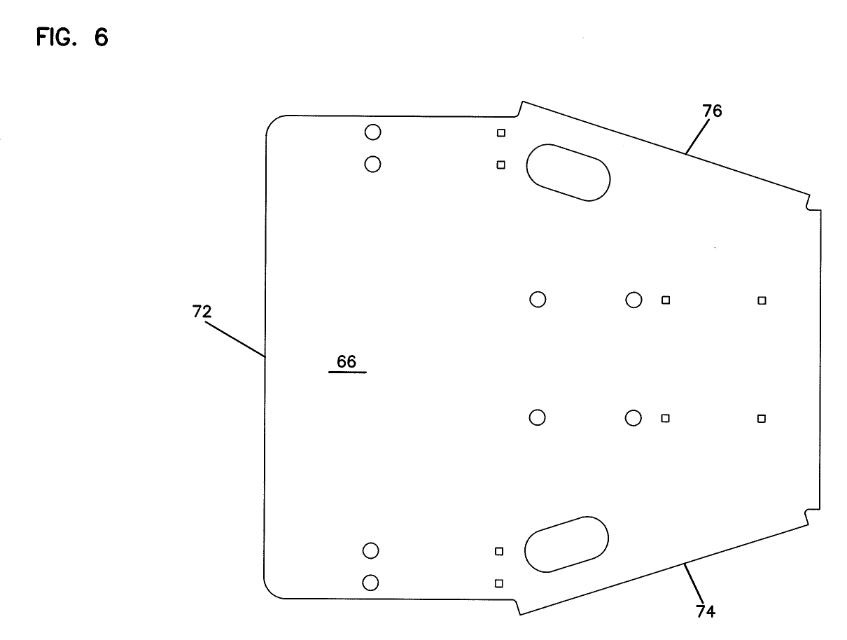

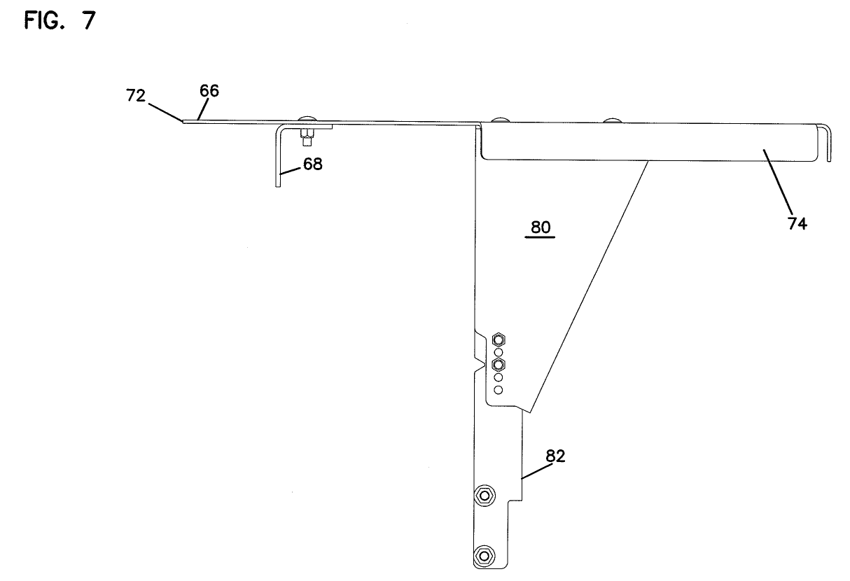

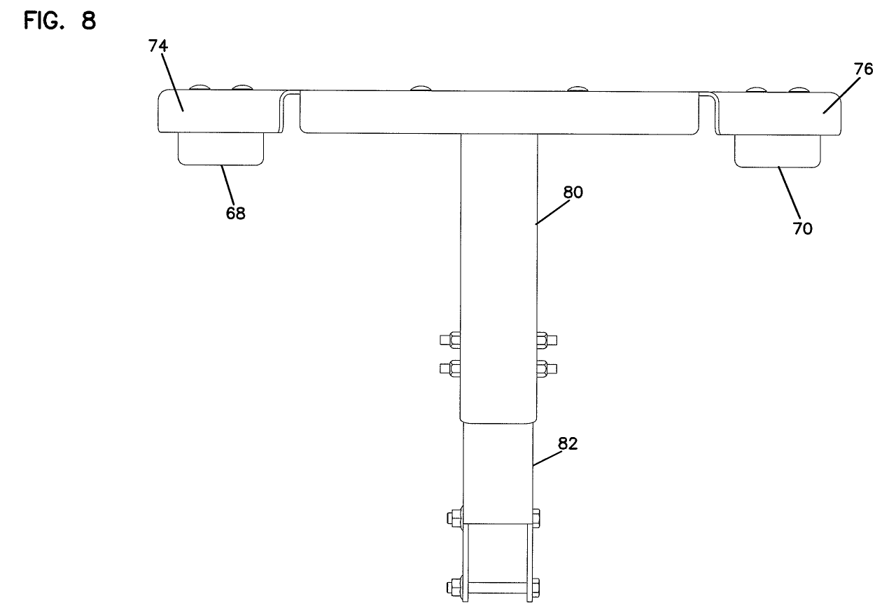

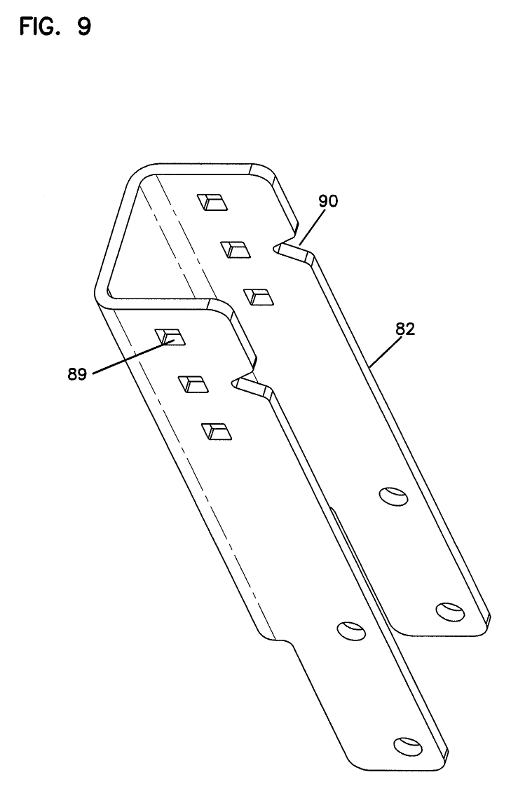

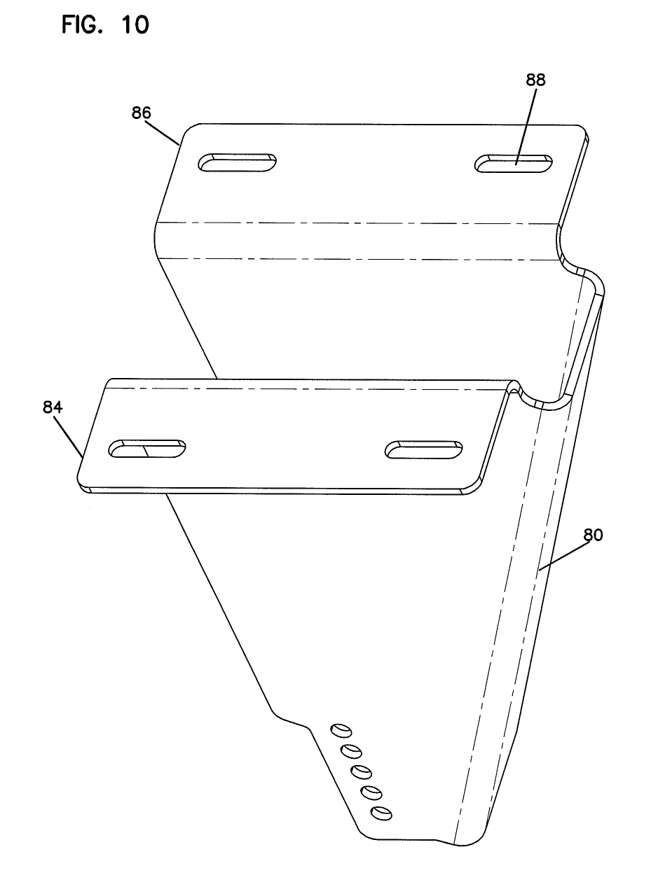

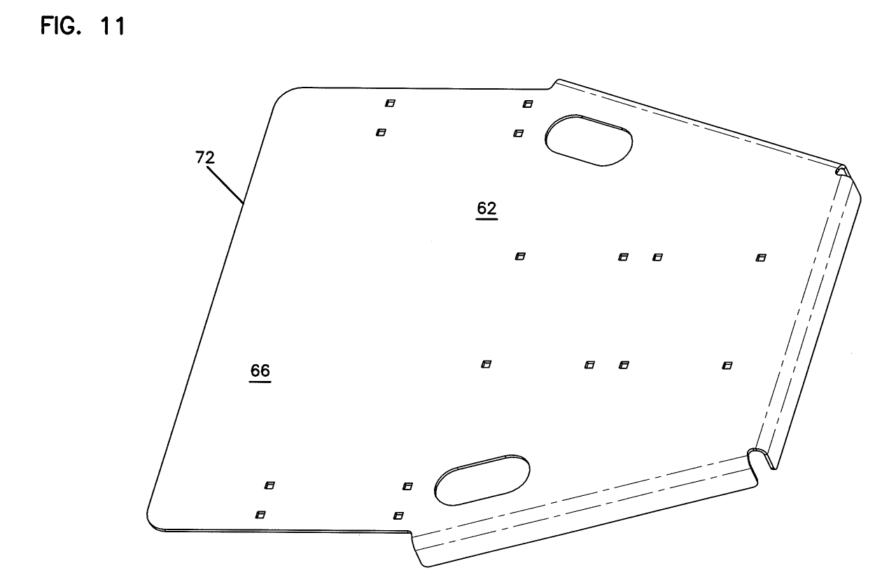

Referring to FIGS. 5-11, an alternative embodiment of the bed extender is described. The depicted alternative embodiment includes many of the same or similar features to the above-described embodiment. For efficiency the present description will focus on the differences between the depicted embodiments.

Referring to FIGS. 5-8, and 11, the bed extender 60 includes a table portion 62 (also referred to herein as a bed plate) connected to a hitch mounting assembly 64. In the depicted embodiment, the table portion 62 includes a flange 66 configured to rest over the back edge 28 of the truck bed 10 and a pair of bumpers 68, 70 configured to abut against the back edge 28 of the truck bed 10. In the depicted embodiment the flange 66 is generally horizontal, and the bumpers 68, 70 are generally vertical. In the depicted embodiment, the location of the bumpers 68, 70 relative to the table portion 62 is adjustable. For application where the greater extension is desired, the bumpers 68, 70 are mounted to the table portion 62 at a location that is relatively closer to the front edge 72 of the bed extender 60. For application where less extension is desired, the bumpers 68, 70 are mounted to the table portion 62 at a location that is relatively further from the front edge 72 of the bed extender 60. In the depicted embodiment the bumpers 68, 78 are bolted through the table portion 62.

In addition, table portion 62 also has a different shape than the table portion 22. Also, the side edges 74, 76 of table 62 are bent downward like the end edge of both table 22 and table 62. In both of the depicted embodiments the front edge (the edge configured to rest on the truck bed) is longer than the rear edge (the edge configured to extend rearward from the truck). In both depicted embodiments the length of the front edge is substantially less than the width of the truck bed. In the depicted embodiment the length of the front edge is less than seventy-five percent of the width of the truck bed. In the depicted embodiment, the length of the front edge is between 10 to 60 inches and the length of the rear edge is between 6 to 48 inches. More preferably, the length of the front edge is between 15 to 36 inches and the length of the rear edge is between 12 to 18 inches. In the depicted embodiment the side edges 74, 76 are angled (tapered) towards the rear edge of the table. The shape of the table according to the depicted embodiment avoids contact between the bed extenders and any trailer being towed by the truck, even when the truck takes relatively tight turns. Despite the general similarities in the shapes of the tables 22 and 62, it should be appreciated that many other alternative table configurations are also possible.

Referring to FIGS. 5-8, and 10, the bed extender 60 includes a hitch mounting assembly 64 including a first vertical support member 80 connected to the table 62 and a second vertical support member 82 configured to connect to a portion of the hitch 18. In the depicted embodiment, the first vertical support member 80 includes an upper end with opposed flanges 84, 86 that each have slots 88 configured to receive bolts. The slots enable the lateral position of the hitch mounting assembly and the table 62 to be adjusted. The lower end of the first vertical support member 80 includes through holes that are configured to receive bolts that attach the first vertical support member to the second vertical support member 82. In the depicted embodiment the first vertical support member is formed by bending a single piece of metal. It should be appreciated that many alternative configurations and forming processes are also possible.

In the depicted embodiment, the second vertical support member 82 is sized such that the table 62 can be supported in a generally horizontal position. The upper portion of the second vertical support member 82 can include a plurality of holes 89 to enable the level of the table 62 to be adjusted as desired. In the depicted embodiment the second vertical support member 82 telescopes from the first vertical support member 80. The second vertical support member 82 also includes a notch 90 that can be used as a visual reference for the height adjustment of the table 62. In some embodiments the notch 90 is configured to be aligned with numbers that are stamped into the first vertical member 80.

It should be appreciated that the bed extenders according to the present disclosure can be used to transport a variety of different objects in a truck bed (e.g., motorcycles, snowmobiles, ATVs, couches, lumber, etc.). In the context of transporting a motorcycle, the device is used by securing it to the receiver of the truck, strapping it to the truck bed such that the table portion abuts the edge of the truck bed, connecting a ramp to the loading edge of the table, and rolling a motorcycle into the truck bed such that the front or the back wheel rests on the table portion of the bed extender.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A pickup truck bed extender comprising:
a table including a portion configured to rest over a rear edge of a truck bed and a portion configured to extend reward from the truck bed; and
a vertical support assembly including a first end connected to the table and a second end configured to be supported by a receiver of the pickup truck;
wherein the width of a distal end of the portion configured to extend rearward of the truck bed measured in a direction parallel to the rear of the truck bed is less than 48 inches.

2. The device of claim 1, wherein the vertical support assembly includes a lower portion configured to be connected to a member extending from a receiver of the pickup truck.

3. The device of claim 2, wherein the member extending from a receiver of the pickup truck is a hitch and the lower portion bolts over and under a portion of the hitch.

4. The device of claim 1, wherein the length of the vertical support assembly is adjustable.

5. The device of claim 4, wherein the vertical support member includes an upper member and a lower member wherein the upper and lower members are arranged in a telescoping configuration.

6. The device of claim 1, wherein the table includes a vertical bumper that is configured to abut the edge of a truck bed.

7. The device of claim 1, wherein the table includes at least two spaced apart connection points configured to engage straps.

8. The device of claim 7, wherein the connection points include two spaced apart apertures.

9. The device of claim 1, wherein the width of a distal end of the portion configured to extend rearward of the truck bed measured in a direction parallel to the rear of the truck bed is less than 36 inches.

10. A method of attaching a bed extender to a pickup truck comprising:
removing a tailgate from the pickup truck;
attaching a lower portion of the bed extender to a hitch receiver of the pickup truck; and
securing an upper portion of the bed extender to an edge of a truck bed of the pickup.

11. The method of claim 10, wherein the step of attaching the lower portion of the bed extender to the hitch receiver comprises inserting a hitch into the hitch receiver and connecting a lower end of the bed extender to a neck portion of the hitch.

12. The method of claim 10, further comprising adjusting the lower portion of the bed extender so that the upper portion of the bed extender is generally level with the bed of the pickup truck.

13. The method of claim 10, wherein the step of securing the upper portion of the bed extender to the edge of a truck includes strapping the upper portion of the bed extender to the tuck.

14. The method of claim 13, wherein the step of securing the upper portion of the bed extender to the edge of a truck includes securing bumpers extending downwardly from a table portion of the bed extender against the truck.

15. The method of claim 10, further comprising connecting a ramp to the upper portion of the bed extender; and rolling the motorcycle into the pickup truck such that at least one of the front or back wheel of the motorcycle rests over the upper portion of the bed extender.

16. A pickup truck bed extender comprising:
a table including a rear edge, a front edge, and side edges, wherein the front edge is configured to be positioned adjacent a truck bed, the rear edge is configured to be positioned away from the truck bed, and the side edges extend between the rear edge and the front edge; and
a vertical support assembly including a first end connected to the table and a second end configured to be supported by a receiver of the pickup truck, wherein the length of the vertical support assembly is adjustable;
wherein the length of the rear edge is less than 48 inches.

17. The device of claim 16, wherein the rear edge is shorter than the front edge, and wherein side edges of the table are tapered toward the rear edge.

18. The device of claim 16, wherein the vertical support assembly is connected to the table via bolts that extend through apertures in flanges of the vertical support assembly.

19. The device of claim 16, wherein the vertical support assembly includes a portion configured to be secured to a member extending from a receiver of the pickup truck.

20. The device of claim 19, wherein the member extending from a receiver of the pickup truck is a hitch.
